(19) United States
(12) Patent Application Publication
(10) Pub. No.: US 2021/0243421 A1
(43) Pub. Date: Aug. 5, 2021

(54) Stereo Camera Device and Method for Operating the Stereo Camera Device

(71) Applicant: Conti Temic microelectronic GmbH, Nuernberg (DE)

(72) Inventor: Guenter Anton FENDT, Schrobenhausen (DE)

(21) Appl. No.: 17/052,588

(22) PCT Filed: Jul. 3, 2019
(86) PCT No.: PCT/DE2019/200070

§ 371 Date: Nov. 3, 2020

(30) Foreign Application Priority Data
Jul. 9, 2018 (DE) 10 2018 211 268.1

(51) Int. Cl. H04N 13/239; H04N 13/246; G06T 7/593

(52) U.S. Cl. CPC H04N 13/239; H04N 13/246; H04N 2013/0081; G06T 2207/10012; G06T 7/593

(57) ABSTRACT

The invention relates to a stereo camera device for a motor vehicle, comprising: a first and a second mono camera, the first and second mono cameras each having at least one optical system and an image sensor for sensing images; an evaluation device, the image sensor of the first mono camera and the image sensor of the second mono camera being connected to the evaluation device in order to transmit image data of the sensed images. The evaluation device is designed: to evaluate a first stereo image from the image data transmitted to the first and second mono camera, using a stereo camera algorithm; to evaluate a second stereo image from the image data transmitted to the first mono camera, using a mono algorithm; to determine image depth information from each of the first and the second stereo images; and to check that the image depth information that has been determined from the first and the second stereo images corresponds.

The invention relates to a stereo camera device according to the preamble of claim 1. Furthermore, the invention relates to a motor vehicle having the stereo camera device and a method for operating the stereo camera device.

Driver assistance systems in vehicles frequently use one or more cameras to sense the vehicle environment, for example to recognize an extremely wide range of objects in the vehicle environment. As a general rule, the cameras are arranged in the vehicle interior behind the windshield and look through the windshield in the direction of travel. Vehicle cameras for recognizing obstacles, road markings, traffic signs and other road users are, for example, known.

At present, stereo camera systems are preferably deployed during the establishment of object distances by means of cameras. As a general rule, these consist of two identical camera modules (single cameras) which are constructed as separate optical systems, each having an image acquisition element and an imaging system.

A stereo camera system, comprising two self-contained mono cameras and a stereo image evaluation unit, is known from the printed publication DE 10 2014 206 227 A1. In order to increase the reliability, the first and second mono cameras are each designed to evaluate images, using a mono camera algorithm and the stereo image evaluation unit is designed for stereoscopic image evaluation of the image data of the first and second mono cameras, using a stereo image algorithm. In the event of a defect occurring, for example in one of the two mono cameras, stereo evaluation is no longer possible, although mono information is still available, so that the reliability is increased due to the fact that double the amount of environmental information is available.

However, this type of verification does not solve the problem that the correct functionality of the stereo camera device can be identified as such. For example, the possibility cannot be excluded of individual components of the stereo camera device loosening mechanically due to ageing. Examples of this are a displaced camera lens or a displaced image sensor due to a loosening adhesive joint or respectively a loosened screw. In such cases, due to the mechanically incorrectly arranged individual parts, a faulty stereo evaluation is henceforth carried out.

It is therefore an object of the invention to provide a stereo camera device and a method, in which the recognition of a defective stereo evaluation is made possible.

The object is achieved by a stereo camera device having the features of claim 1, a motor vehicle having the features of claim 4 and by a method having the features of claim 5.

A stereo camera device for a motor vehicle is proposed. For example, the stereo camera device can be integrated into a driver assistance system of the motor vehicle or can be connected thereto. The driver assistance system comprises e.g. an (emergency) brake assistant, an (emergency) steering assistant, a parking assistant, an adaptive cruise control system and/or a lane departure warning system. Such driver assistance functions are, for example, essential for highly autonomous driving.

The stereo camera device comprises a first and a second mono camera, the first and second mono cameras each having at least one image sensor and an optical system for sensing images. The first and the second mono cameras are preferably laterally offset, i.e. arranged offset on a line parallel to the transverse axis of the vehicle. The first and the second mono cameras are designed to be of identical construction, for example.

Furthermore, the stereo camera device comprises an evaluation device, the image sensor of the first mono camera and the image sensor of the second mono camera being connected to the evaluation device in order to transmit the image data produced by the respective image sensor. The image data transmitted to the evaluation device comprise, in particular, at least one image or a sequence of images with at least two images from the respective mono camera.

The evaluation device is designed to evaluate a first stereo image from the image data transmitted to the first and second mono camera, using a stereo camera algorithm. In particular, during the evaluation of the stereo image, using the stereo camera algorithm, a data fusion of image information from the image data transmitted by the first and the second mono camera is effected. An establishment of object distances from the ego motor vehicle is advantageously made possible by means of the stereo image.

Moreover, the evaluation device is designed to evaluate a second stereo image from the image data transmitted to the first mono camera, using a mono algorithm, in particular using a Structure-from-Motion algorithm. In particular, the Structure-from-Motion algorithm denotes a reconstruction of structures such as sizes, clearances, angular similarities and expanses from images which are offset in time with respect to one another, generated by exclusively one of the two mono cameras. In other words, a stereo image is created in particular from serially sensed image data of a mono camera.

The evaluation device is designed to determine, in particular, redundant image depth information such as e.g. the distance of the stereo camera device from an object, from each of the first and second stereo images.

According to the invention, the evaluation device is designed to check that the image depth information that has been determined from the first and the second stereo images corresponds. In this way, it is possible to ascertain a mechanical defect or respectively an offset or slipped arrangement of individual components in the stereo camera system and, as a consequence, to avoid a defective evaluation of image information. Consequently, the vehicle safety is ensured.

In a preferred embodiment, the evaluation device is designed to evaluate a third stereo image from the image data of the second mono camera, the evaluation device being designed to check that the image depth information that has been determined from the first and the third sensed stereo images corresponds.

Consequently, the examination is advantageously and inexpensively made more precise.

In a further preferred embodiment, the evaluation device is designed to check that the image depth information that has been determined from the second and the third sensed stereo images corresponds. Consequently, the correct arrangement of the stereo camera device is checked again and, consequently, monitored more precisely.

A further subject matter of the invention relates to a motor vehicle having a stereo camera device, the motor vehicle having a driver assistance system which is designed, in the event of a discrepancy in the checked image depth information, to output a warning to the driver and/or to switch off.

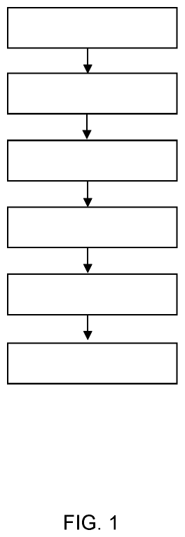

A further subject matter of the invention relates to a method for operating the stereo camera device in accordance with the foregoing description. FIG. 1 shows a schematic depiction of the course of the method according to the invention.

In a first step, image sensors of the first and second mono cameras sense images, the images being transmitted as image data to the evaluation device. The first stereo image from the image data transmitted by the first and the second mono camera is evaluated, and the second stereo images from the image data transmitted by the first mono camera is evaluated. The image depth information from the first and second stereo image is subsequently transmitted and checked for correspondence. Consequently, the determined image depth information or respectively a determined clearance from an object or obstacle is, in particular, verified.

1. A stereo camera device for a motor vehicle, comprising
a first and a second mono camera, the first and second mono cameras each having at least one optical system and an image sensor for sensing images;
an evaluation device, the image sensor of the first mono camera and the image sensor of the second mono camera being connected to the evaluation device in order to transmit image data of the sensed images;
the evaluation device being designed:
to evaluate a first stereo image from the image data transmitted to the first and second mono camera, using a stereo camera algorithm;
to evaluate a second stereo image from the image data transmitted to the first mono camera, using a mono algorithm;
to determine image depth information from each of the first and the second stereo images;
characterized in that
the evaluation device is designed to check that the image depth information that has been determined from the first and the second stereo images corresponds.

2. The stereo camera device according to claim 1, characterized in that the evaluation device is designed to evaluate a third stereo image from the image data of the second mono camera, the evaluation device being designed to check that the image depth information that has been determined from the first and the third sensed stereo images corresponds.

3. The stereo camera device according to claim 2, characterized in that the evaluation device is designed to check that the image depth information that has been determined from the second and the third sensed stereo images corresponds.

4. A motor vehicle having a stereo camera device according to claim 1, characterized by a driver assistance system which is designed, in the event of a discrepancy in the checked image depth information, to output a warning to the driver.

5. A method for operating a stereo camera device according to claim 1, characterized by the following steps:
sensing of images by the image sensor of the first and second mono cameras,
transmission of image data of the sensed images to the evaluation device,
evaluation of a first stereo image from the image data transmitted by the first and the second mono camera,
evaluation of a second stereo image from the image data transmitted by the first mono camera,
determination of image depth information from the first and the second stereo images;
checking that the image depth information that has been determined from the first and the second stereo images corresponds.
